(19) United States
(12) Patent Application Publication
(10) Pub. No.: US 2023/0419176 A1
(43) Pub. Date: Dec. 28, 2023

(54) MACHINE LEARNING TECHNIQUES FOR PREDICTIVE MULTI-VARIATE TEMPORAL FEATURE IMPACT DETERMINATIONS

(71) Applicant: Wells Fargo Bank, N.A., San Francisco, CA (US)

(72) Inventors: Tianjie Wang, Charlotte, NC (US); Joel Vaughan, Charlotte, NC (US); Vijayan Nair, Matthews, NC (US); Agus Sudjianto, Charlotte, NC (US); Jie Chen, Fremont, CA (US)

(21) Appl. No.: 18/190,745

(22) Filed: Mar. 27, 2023

Related U.S. Application Data
(60) Provisional application No. 63/367,098, filed on Jun. 27, 2022.

(51) Int. Cl. G06N 20/00

(52) U.S. Cl. CPC G06N 20/00

(57) ABSTRACT

Systems, apparatuses, methods, and computer program products are disclosed for generating a predictive temporal feature impact report using a feature engineering machine with attention for time series (FEATS model). An example method includes receiving an entity input data object. The method further includes determining one or more attention head scores for each feature attention head included in the FEATS model based at least in part on one or more per-temporal feature time impact scores over each time window for each temporal feature set. The method further includes generating a predictive temporal feature impact report based at least in part on at least one of the one or more attention head scores for each attention head or the one or more per-temporal feature time impact scores for each temporal feature time point as determined in each attention head.

### CROSS REFERENCE TO RELATED APPLICATIONS

The present application claims the benefit of U.S. Provisional Application No. 63/367,098, filed Jun. 27, 2022, which is hereby incorporated by reference in its entirety.

### BACKGROUND

Various embodiments of the present invention address technical challenges related to performing predictive data analysis operations and address efficiency and reliability shortcomings of various existing predictive data analysis solutions, in accordance with at least some of the techniques described herein.

### BRIEF SUMMARY

In general, embodiments of the present invention provide methods, apparatus, systems, computing devices, computing entities, and/or the like for performing predictive data analysis operations for predictive contribution determinations for various entities. For example, certain embodiments of the present invention utilize systems, methods, and computer program products that perform predictive data analysis operations on an entity input data object using a feature engineering machine with attention for time series (FEATS) model.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 provides an exemplary overview of an architecture that can be used to practice some embodiments of the present invention.

FIG. 2 provides an example predictive data analysis computing entity in accordance with some embodiments described herein.

FIG. 3 provides an example client computing entity in accordance with some embodiments described herein.

FIG. 4 illustrates an example flowchart for generating a predictive temporal feature impact report, in accordance with some example embodiments described herein.

FIG. 5 illustrates an example flowchart for generating one or more attention head scores for a respective feature attention head, in accordance with some example embodiments described herein.

FIG. 6 illustrates an attention subnet structure, which may be utilized by one or more feature attention heads in accordance with some example embodiments described herein.

FIG. 7 illustrates an example feature attention head structure, in accordance with some example embodiments described herein.

FIG. 8 illustrates an example FEATS model, in accordance with some example embodiments described herein.

FIG. 9A illustrates attention weights of the first of two feature attention heads in example 1.

FIG. 9B illustrates attention weights of the first of two feature attention heads in example 1.

FIG. 9C illustrates attention weights of the first of two feature attention heads in example 1.

FIG. 9D illustrates attention weights of the second of two feature attention heads in example 1.

FIG. 9E illustrates attention weights of the second of two feature attention heads in example 1.

FIG. 9F illustrates attention weights of the second of two feature attention heads in example 1.

FIG. 10A illustrates an interpretation plot of feature engineering heads generated and used in example 2.

FIG. 10B illustrates an interpretation plot of feature engineering heads generated and used in example 2.

FIG. 10C illustrates an interpretation plot of feature engineering heads generated and used in example 2.

FIG. 10D illustrates ab interpretation plot of feature engineering heads generated and used in example 2.

FIG. 10E illustrates an interpretation plot of feature engineering heads generated and used in example 2.

FIG. 10F illustrates an interpretation plot of feature engineering heads generated and used in example 2.

FIG. 11A illustrates an interpretation plot generated for the trading dataset described in example 3.

FIG. 11B illustrates an interpretation plot generated for the trading dataset described in example 3.

FIG. 11C illustrates an interpretation plot generated for the trading dataset described in example 3.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

### I. Overview and Technical Advantages

Various embodiments of the present invention relate to determining a predictive action to take for one or more entities based on associated per-temporal feature time impact scores, attention head scores, overall model response, and/or the like as generated using a FEATS model, thereby also providing interpretability of otherwise black-box outputs generated by the FEATS model. While the use of such machine learning techniques may allow for consideration of a wide range of features and associated increased predictive accuracy, such techniques often lack interpretability. For example, financial institutions may use machine learning techniques to forecast market fluctuations, financial account balances, etc. Further complicating matters may be the underlying time dependence of such data, which may be difficult to preserve in traditional models. For example, certain traditional modeling techniques may concatenate multi-variate temporal inputs into a one-dimensional array, thereby destroying the multi-variate temporal structure of such inputs, thereby losing time-dependent and cross-variable relationships.

To address the above-noted technical challenges, various embodiments of the present invention describe a FEATS model configured to generate per-temporal feature time impact scores, attention head scores, overall model response, etc. as well as a predictive temporal feature impact report based on the one or more generated scores. The predictive temporal feature impact report may additionally include visual representations of the one or more generate scores and thus, the FEATS model may provide for an accurate prediction forecasting while also providing for interpretability of the impact of particular temporal feature time points, temporal feature sets (e.g., features), attention head scores, and/or the like.

Various embodiments of the present invention also address technical challenges for preserving the multi-variate temporal structure of input data by using one or more feature attention heads, which each generate a respective attention head score. Each feature attention head is associated with a feature attention layer configured to process each temporal feature set over an associated time window without concatenating the input data. The time window may be customized for each feature attention head. Thus, the FEATS model may preserve the structure of the multi-variate temporal feature data and thus, maintain the time-dependent integrity of such data.

Furthermore, in some embodiments, FEATS model may additionally consider the impact of temporally static features, thereby allowing for a hybrid predictive model which is indicative of the impact of both time-dependent and time-independent features. The FEATS model may transform the one or more temporally static features by applying one or more transformation functions to each temporally static feature to generate respective temporally static features and further, generate a static feature vector based on the one or more transformed static features. The static feature vector may be used when determining the one or more overall model response and used in the predictive temporal feature impact report.

Additionally, the architecture of the FEATS model allows for parallel processing of each temporal feature set by the one or more feature attention heads. As such, the one or more attention head scores generated by each feature attention head may be generated using one or more separate processing elements, computing entities, and/or the like. This allows for a reduction in the required computational time and the computational complexity of runtime operations on a single processing element and/or computing entity while still maintaining model accuracy.

Thorough analyses on both simulated data and public real data demonstrate both of these results. In addition, it is possible to increase interpretability of a generated entity score for an entity based on the entity score and a selected reference score. Greater detail regarding specifics of example implementations is disclosed herein.

Although a high-level explanation of the operations of example embodiments has been provided above, specific details regarding the configuration of such example embodiments are provided below.

### II. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### III. Example System Framework

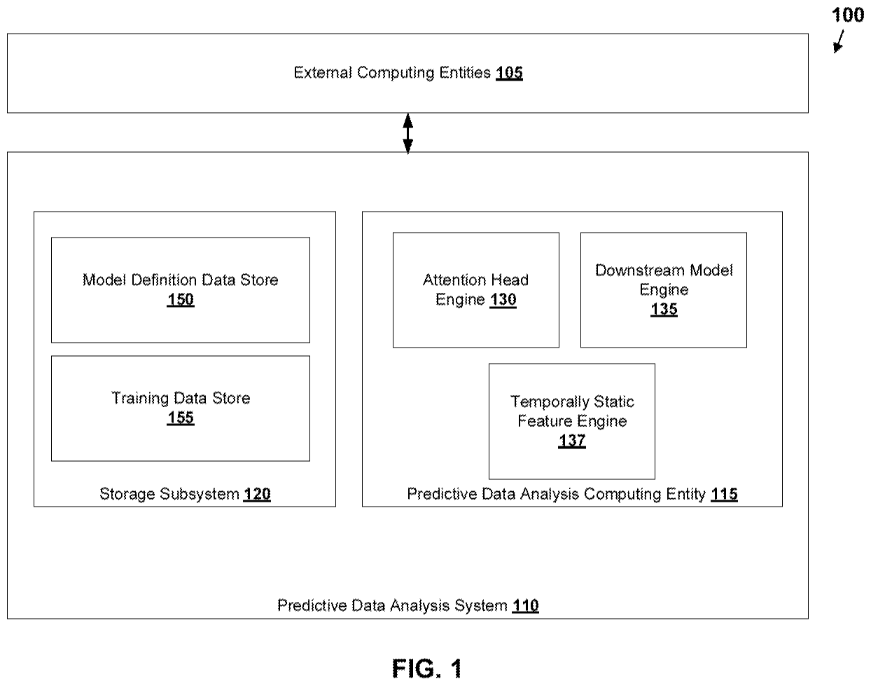

FIG. 1 is a schematic diagram of an example system architecture 100 for performing predictive data analysis operations and for performing one or more prediction-based actions (e.g., generating a predictive temporal feature impact report). The system architecture 100 includes a predictive data analysis system 110 comprising a predictive data analysis computing entity 115 configured to generate predictive outputs that can be used to perform one or more prediction-based actions. The predictive data analysis system 110 may communicate with one or more external computing entities 105 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The system architecture 100 includes a storage subsystem 120 configured to store at least a portion of the data utilized by the predictive data analysis system 110. The predictive data analysis computing entity 115 may be in communication with one or more external computing entities 105. The predictive data analysis computing entity 115 may be configured to train a prediction model (e.g., a predictive multi-variate temporal determination prediction machine learning model) based at least in part on the training data 155 stored in the storage subsystem 120, store trained prediction models as part of the model definition data store 150 stored in the storage subsystem 120, utilize trained models to generate predictions based at least in part on prediction inputs provided by an external computing entity 105, and perform prediction-based actions based at least in part on the generated predictions. The storage subsystem may be configured to store the model definition data store 150 for one or more predictive analysis models and the training data 155 uses to train one or more predictive analysis models. The predictive data analysis computing entity 115 may be configured to receive requests and/or data from external computing entities 105, process the requests and/or data to generate predictive outputs and provide the predictive outputs to the external computing entities 105. The external computing entity 105 may periodically update/provide raw input data (e.g., an entity input data object) to the predictive data analysis system 110.

The storage subsystem 120 may be configured to store at least a portion of the data utilized by the predictive data analysis computing entity 115 to perform predictive data analysis steps/operations and tasks. The storage subsystem 120 may be configured to store at least a portion of operational data and/or operational configuration data including operational instructions and parameters utilized by the predictive data analysis computing entity 115 to perform predictive data analysis steps/operations in response to requests. The storage subsystem 120 may include one or more storage units, such as multiple distributed storage units that are connected through a computer network. Each storage unit in the storage subsystem 120 may store at least one of one or more data assets and/or one or more data about the computed properties of one or more data assets. Moreover, each storage unit in the storage subsystem 120 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 115 includes an attention head engine 130, a downstream model engine 135, and may include a temporally static feature engine 137. The predictive data analysis computing entity 115 may be configured to perform predictive data analysis based at least in part on entity input data object. For example, the attention head engine 130 may be configured to perform one or more prediction-based actions based on each per-temporal feature time impact score for each temporal feature time point in a temporal feature set, an attention head score. The downstream model engine 135 may be configured to receive per-head feature scores from the attention head engine 130 and provide an overall model response in accordance with the training data 155 stored in the storage subsystem 120. The Temporally static feature engine 137 may be configured to provide additional inputs to the downstream model engine 135 based on one or more temporally static features.

### Example Predictive Data Analysis Computing Entity

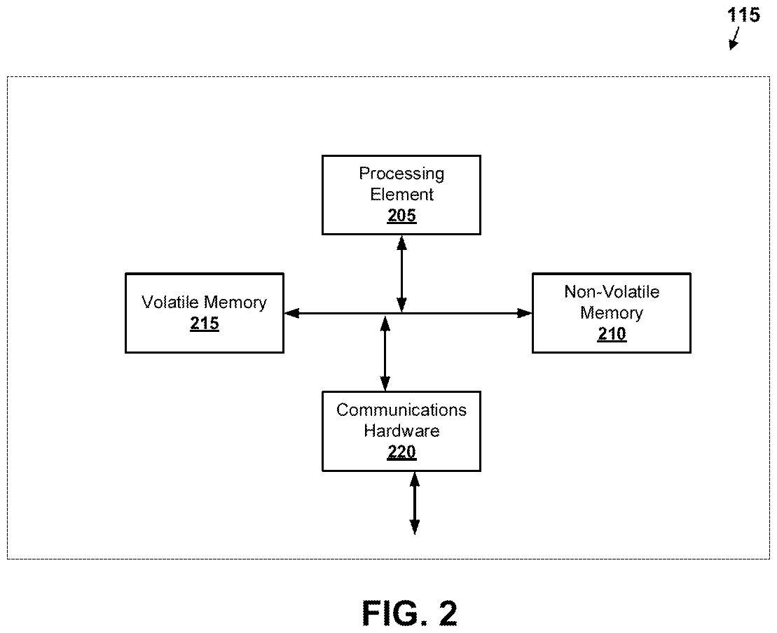

FIG. 2 provides a schematic of a predictive data analysis computing entity 115 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

As indicated, in one embodiment, the predictive data analysis computing entity 115 may also include a communications hardware 220 for communicating with various computing entities, such as by communicating data, content, information, and/or similar terms used herein interchangeably that can be transmitted, received, operated on, processed, displayed, stored, and/or the like.

The communications hardware 220 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

As shown in FIG. 2, in one embodiment, the predictive data analysis computing entity 115 may include or be in communication with a processing element 205 (also referred to as processors, processing circuitry, and/or similar terms used herein interchangeably) that communicate with other elements within the predictive data analysis computing entity 115 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 115 may further include or be in communication with non-volatile media (also referred to as non-volatile storage, memory, memory storage, memory circuitry and/or similar terms used herein interchangeably). In one embodiment, the non-volatile storage or memory may include at least one non-volatile memory 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 115 may further include or be in communication with volatile media (also referred to as volatile storage, memory, memory storage, memory circuitry and/or similar terms used herein interchangeably). In one embodiment, the volatile storage or memory may also include at least one volatile memory 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 115 with the assistance of the processing element 205 and operating system.

As indicated, in one embodiment, the predictive data analysis computing entity 115 may also include a communications hardware 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 115 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example External Computing Entity

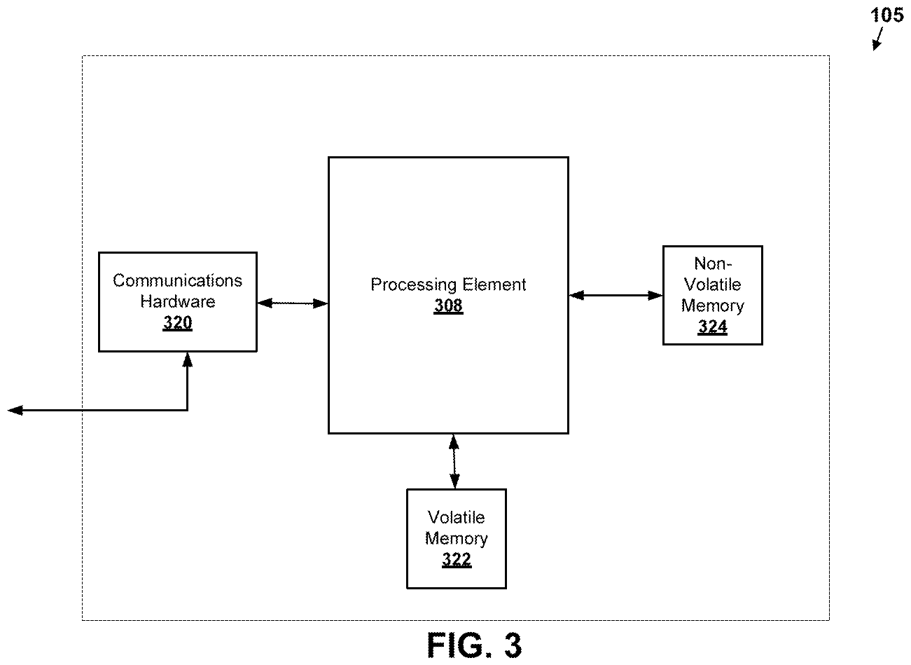

FIG. 3 provides an illustrative schematic representative of an external computing entity 105 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. External computing entities 105 can be operated by various parties. As shown in FIG. 3, the external computing entity 105 can include antennas, transmitters (e.g., radio), receivers (e.g., radio), and a processing element 308 (e.g., CPLDs, microprocessors, multi-core processors, coprocessing entities, ASIPs, microcontrollers, and/or controllers) that provide signals to and receives signals from other computing entities. Similarly, the external computing entity 105 may operate in accordance with multiple wired communication standards and protocols, such as those described above with regard to the predictive data analysis computing entity 115 via a communications hardware 320.

Via these communication standards and protocols, the external computing entity 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 105 can also download changes, add-ons, and updates, for instance, to its firmware, software (e.g., including executable instructions, applications, program modules), and operating system.

The external computing entity 105 may also comprise a user interface (that can include a display coupled to a processing element) and/or a user input interface (coupled to a processing element 308). For example, the user interface may be a user application, browser, user interface, and/or similar words used herein interchangeably executing on and/or accessible via the external computing entity 105 to interact with and/or cause display of information/data from the predictive data analysis computing entity 115, as described herein. The user input interface can comprise any of a number of devices or interfaces allowing the external computing entity 105 to receive data, such as a keypad (hard or soft), a touch display, voice/speech or motion interfaces, or other input device.

The external computing entity 105 can also include volatile storage or memory 322 and/or non-volatile storage or memory 324, which can be embedded and/or may be removable. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 105. As indicated, this may include a user application that is resident on the entity or accessible through a browser or other user interface for communicating with the predictive data analysis computing entity 115 and/or various other computing entities.

In another embodiment, the external computing entity 105 may include one or more components or functionality that are the same or similar to those of the predictive data analysis computing entity 115, as described in greater detail above. As will be recognized, these frameworks and descriptions are provided for exemplary purposes only and are not limiting to the various embodiments.

In various embodiments, the external computing entity 105 may be embodied as an artificial intelligence (AI) computing entity, such as an Amazon Echo, Amazon Echo Dot, Amazon Show, Google Home, and/or the like. Accordingly, the external computing entity 105 may be configured to provide and/or receive information/data from a user via an input/output mechanism, such as a display, a video capture device (e.g., camera), a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### VI. Example Operations

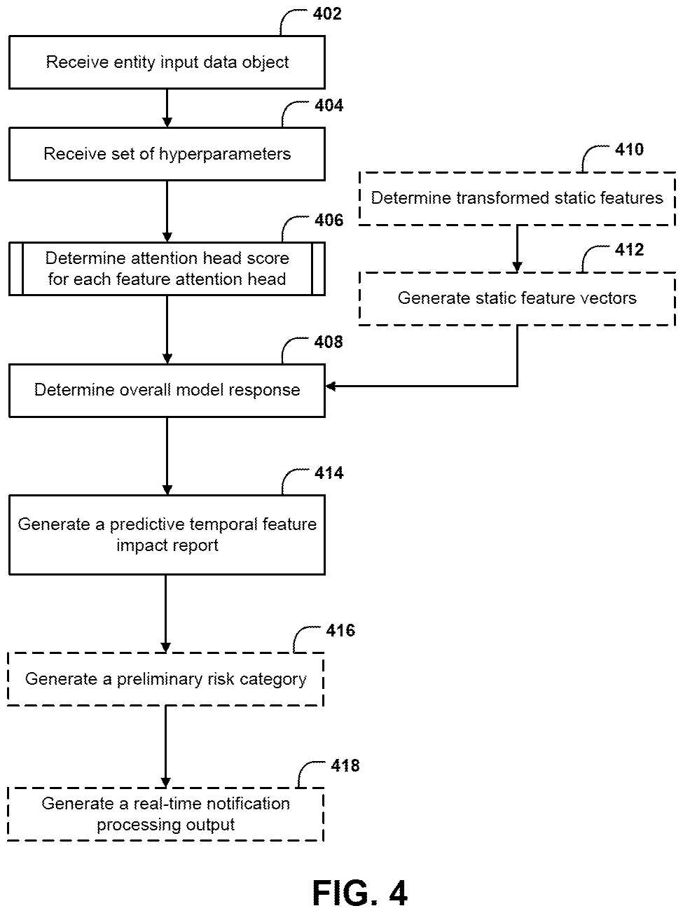

Turning to FIG. 4, an example flowchart is illustrated that contains example operations implemented by various embodiments contemplated herein. The operations illustrated in FIG. 4 may, for example, be performed by an apparatus such as predictive data analysis computing entity 115, which is shown and described in connection with FIG. 1. To perform the operations described below, the predictive data analysis computing entity 115 may utilize one or more of processing element 205, volatile memory 215, non-volatile memory 210, communications hardware 220, other components, and/or any combination thereof. It will be understood that user interaction with the predictive data analysis computing entity 115 may occur directly via communications hardware 220, or may instead be facilitated by a device that in turn interacts with predictive data analysis computing entity 115.

As shown by operation 402, predictive data analysis computing entity 115 includes means, such as processing element 205, communications hardware 220, or the like, for receiving an entity input data object. The entity input data object may include entity data for an entity, a collection of entities, and/or the like. The entity input data object may also include a requested action and a forecast timeframe. For example, the entity input data object may describe various stock market trading feature values for a particular portfolio over a period of time and the requested action may be a prediction of the direction of change of the stocks in the portfolio within the next 3 milliseconds (e.g., the forecast timeframe). The entity input data object may be a structured or semi-structured data object. For example, the entity input data object may include a collection of vectors, matrices, tensors, and/or the like. In particular, the entity input data object may describe at least one or more temporal feature sets.

Each temporal feature set may correspond to a feature of interest. For example, a temporal feature set may describe daily financial account balances for an entity over a given period of time. A temporal feature set may include one or more temporal feature time points, which may be ordered temporally within the entity input data object. By way of continuing example, each temporal feature set may correspond to a vector, matrix, tensor, or the like. The one or more temporal feature time points may correspond to a particular period of time. For example, a temporal feature time point may correspond to a particular date (e.g., month, day, year, etc.), a time (e.g., minute, hour, day, month, etc.), and/or the like. Each temporal feature time point included in a temporal feature set may be ordered temporally such that the preceding temporal feature time point occurs prior to the time point of interest and similarly, the immediately following temporal feature time point occurs after the time point of interest.

At operation 404, the predictive data analysis computing entity 115 includes means, such as processing element 205, communications hardware 220, or the like, to receive a set of hyperparameters. The set of hyperparameters may include (i) a number of feature attention heads to be included in the FEATS model, (ii) a number of network layers to be included in each feature attention head, (iii) a number of network nodes for each network layer to be included in each feature attention head, (iv) an activation function to be included in each feature attention head, (v) a width of a rolling window to be utilized by each feature attention head, (v) a regularization parameter to be utilized by each feature attention head, or (vi) a combination thereof.

The set of hyperparameters may include a number of feature attention heads. A smaller number of feature attention heads may produce a simpler model that is less susceptible to overfitting. A larger number of feature attention heads may produce a more complex model with more explanatory power.

The set of hyperparameters may include a number of hyperparameters that relate to the feature attention heads. In some embodiments, a feature attention head may comprise one or more neural network models, which may have configurable parameters. For example, the number of network layers, the number of nodes in each network later, the activation functions, and the regularization parameters used in the neural networks may be configurable hyperparameters.

The set of hyperparameters may include a width of a rolling window to be utilized by each feature attention head. The width of the rolling window may depend on the length of the dependence over time and across the multiple time series of the entity input data object. A hyperparameter value that is larger than the length of dependence across time may force weights for edge positions to shrink to zero. Smaller values of the rolling window width may hide certain temporal dependencies in the entity input data object.

The set of hyperparameters may also include a regularization parameter to be utilized by each feature attention head. For example, L1 and L2 penalties may be adjusted when L1 and L2 regularization is used by the feature attention heads. Increasing the values of L1 and L2 parameters may add sparsity on the selection of variables, time points, and attention head scores.

At operation 406, the predictive data analysis computing entity 115 includes means, such as processing element 205, to determine an attention head score for each feature attention head included in the FEATS model. The predictive data analysis computing entity 115 may use the FEATS model to determine the one or more attention head scores for each feature attention head. In some embodiments, the FEATS model may refer to an electronically stored data construct that is configured to describe parameters, hyper-parameters, and/or stored operations of a machine learning model that is configured to process an entity input data object to generate one or more attention head scores for each feature attention head included in the FEATS model. The FEATS model may be configured with one or more feature attention heads. Each feature attention head included in the FEATS model may be trained and/or configured to process all the temporal feature sets, a portion of the temporal feature sets, all of the temporal feature time points included in a temporal feature set, a portion of the temporal feature time points includes in a temporal feature set, and/or the like. Each feature attention head may be trained in parallel with one another such that the training time associated with the FEATS model may be reduced while maintaining model accuracy. In some embodiments, the FEATS model may be a trained neural network model. In particular, in some embodiments, the predictive analysis machine learning model may be an attention-based neural network model. The generated attention head score may be output as a vector comprising numerical values (e.g., binary, decimal, etc.), categorical (e.g., describing one or more temporal feature sets), Boolean value (e.g., true, false), and/or the like.

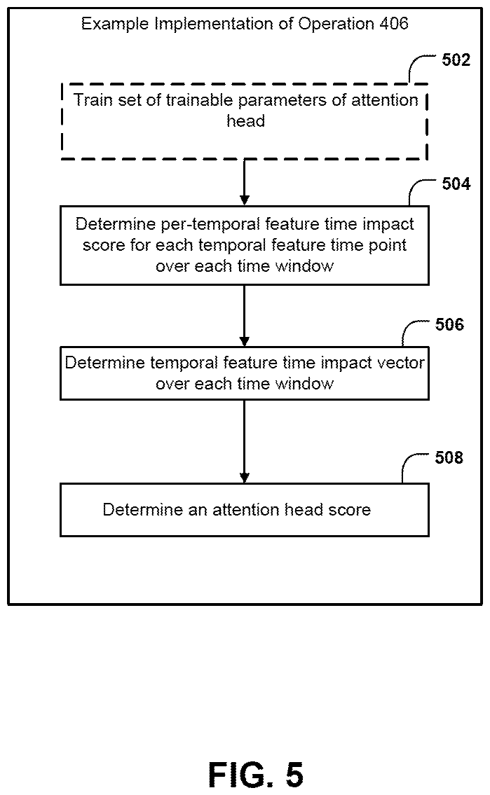

In some embodiments, operation 406 may be performed in accordance with the process that is depicted in FIG. 5, which is an example process for generating an attention head score for a feature attention head. As shown by operation 502, the predictive data analysis computing entity 115 may include means, such as processing element 205, to train a set of trainable parameters of the feature attention head. In some embodiments, the trainable parameters, (e.g., the s k trainable scaling coefficients, described below in connection with Equation 2) may be trained using a machine learning algorithm and a training dataset. The machine learning algorithm may be an optimizing or minimizing algorithm such as stochastic gradient descent algorithm, although other algorithms (including other gradient descent algorithms) may be used in various embodiments. In some embodiments, the training may be performed by an external system, and the predictive data analysis computing entity 115 may receive the trained set of trainable parameters via communications hardware 220 or other means. In embodiments in which the data analysis computing entity 115 trains the feature attention head, each feature attention head may be trained in parallel, and in some embodiments, multiple training datasets may be provided, or the training dataset may be partitioned in various ways. In some embodiments, a portion of the training dataset may be held back for diagnostic or other purposes.

As shown by operation 504, the predictive data analysis computing entity 115 includes means, such as processing element 205, to determine a per-temporal feature time impact score for each time window associated with the feature head. In some embodiments, the FEATS model is further configured to determine a per-temporal feature time impact score for each temporal feature time point included in the temporal feature set over each time window associated with the feature attention head. The feature attention head may be associated with one or more time windows, which may each be associated with a window width. As such, the window width may be indicative of which temporal feature time points from each temporal feature set to process and generate per-temporal feature time impact scores for.

For example, the entity input data object may be expressed as a univariate time series:

X^{[i]}=(X₀^{[i]}, . . . ,X_{T}^{[i]}), (1)

with i=1, . . . , n samples. The feature attention head may include an attention layer, defined as:

$${Feat}^{[ i ]} = {\sum }_{k = 0}^{T} {A}_{k} ( {X}^{[ i ]} ) {s}_{k} {X}_{k}^{[ i ]} , \qquad ( 2 )$$

where the Aₖ(X^{[i]}) are known as attention scores and the sₖ are trainable scaling coefficients.

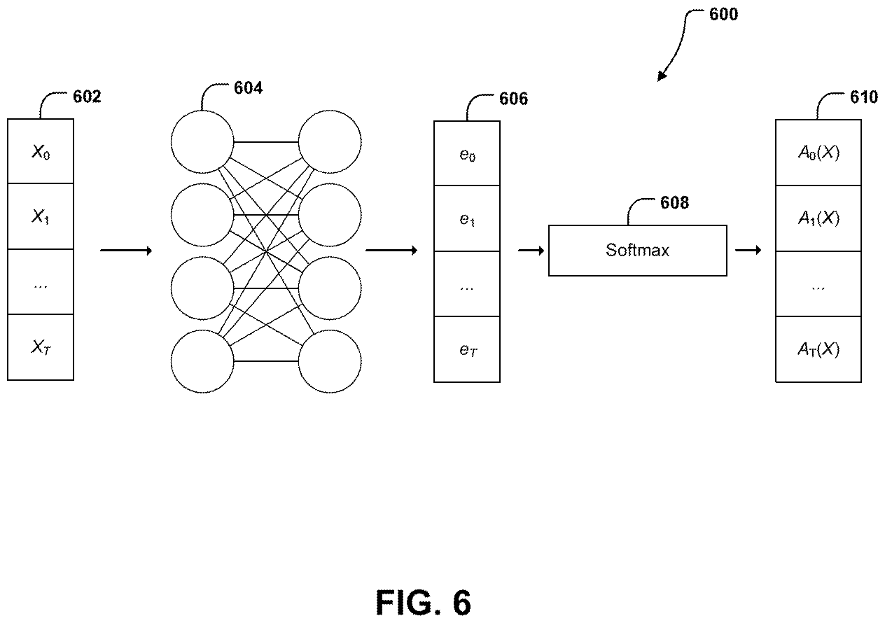

FIG. 6 shows an illustration of the attention subnet structure 600. For each sample i=1, . . . , n, the time series input 602 (X₀, . . . , X_{T}) may be transformed into outputs 606 (e₀, . . . , e_{T}) using a neural network 604 (e.g., a feed-forward neural network (FFNN)). A function then may be applied to transform the outputs, such as the softmax function 608, to obtain attention scores 610 Aₖ=Aₖ(X^{[i]}), for k=1, . . . , T. The softmax function may be expressed as

$$\frac{exp ( {e}_{k} )}{{\sum }_{ℓ = 0}^{T} exp ( {e}_{ℓ} )} .$$

The softmax function may ensure that the Aₖ>0 and the sum of the Aₖ vector is unity. The scaling constants sₖ may be negative values and hence generalize the output.

The above result reflects the importance of time point k in the feature. When T is large, the softmax function forces some of the Aₖ(X^{[i]}[i])Xₖ^{[i]}, to be close to 0. This is like an instance-wise variable selection mechanism that decides which time points get more or less weight in the generated features. The multiplicative interaction term Aₖ(X^{[i]})Xₖ^{[i]} in equation (2) increases the expressivity of the model greatly. This allows for the use of a parsimonious network to learn more flexible features than FFNNs with similar numbers of trained parameters

As described above, a feature attention head may include an attention layer sub-net which may be used to generate the per-temporal feature time impact score for each temporal feature time point. Each feature attention head may be associated with only a portion of the temporal feature sets and/or a portion of the temporal feature time points described by the entity input data object. As such, each feature attention head may only generate a per-temporal feature time impact score for the temporal feature set and/or temporal feature time points associated with the respective attention head. An attention head score for the respective head may be based on each per-temporal feature time impact score associated with the feature attention head.

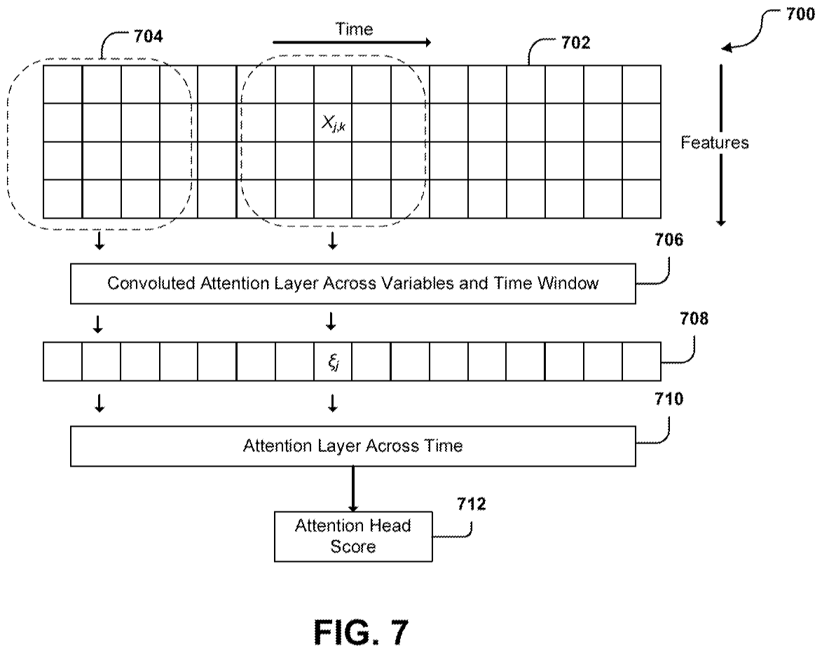

FIG. 7 illustrates an example implementation of the feature attention head 700 for a given index value i representing a temporal feature set (for simplicity the superscript i is omitted in FIG. 7). A shared-weight architecture of convolution kernels 704 may slide along the time index of the time series input 702. The weights of the kernels may change from trainable parameters to trainable functions of the inputs that may be calculated instance by instance. As the convolution layer 706 slides across the time dimension, at every point, relevant information may be combined across the multiple time series of the time series input 702 and surrounding time points into a per-temporal feature time impact score.

The per-temporal feature time impact scores may be used to determine a temporal feature time impact vector 708. The convolution layer 706 may capture complex time patterns and cross-variable interactions with shallower networks, providing more effective interpretation compared to traditional convolutional neural networks such as convolutional neural networks (CNNs). The temporal feature time impact vector 708 may be combined using an attention layer 710, combining the per-temporal feature time impacts scores into an attention head score 712.

Formally, each per-temporal feature time impact score c k may be written (again, omitting the superscript i):

$${ξ}_{k} = {\sum }_{j = 1}^{m} {\sum }_{l = - τ}^{τ} {A}_{j , l}^{1} ( {\tilde{X}}_{k} ) {s}_{j , l}^{1} {X}_{j , ( k + l )}$$

where the time window τ is related to the width of the convolution layer

\tilde{X}ₖ={{X_{j,l}}_{l=(k-τ):(k+τ)}}_{j=1:m}.

The out-of-boundary scripts of the time windows of convolution kernels 704 may be padded with zero values.

Returning to FIG. 5, at operation 506, the predictive data analysis computing entity 115 includes means, such as processing element 205, to determine a temporal feature time impact vector based on one or more determined per-temporal feature time impact scores. In some embodiments, the FEATS model is further configured to determine the temporal feature time impact vector for the associated temporal feature set based at least in part each per-temporal feature time impact score over each time window.

At operation 508, the predictive data analysis computing entity 115 includes means, such as processing element 205, to determine the one or more attention head scores. In some embodiments, the FEATS model is further configured to determine the attention head score based on the associated temporal feature time impacts for each associated time window. In some embodiments, the FEATS model may be configured to apply one or more transformations (e.g., transformation functions) to the temporal feature time impact vectors.

Returning to FIG. 7, the attention layer 710 may combine the [symbol] ={ξₖ} temporal feature time impact vector 708 into the attention head score 712, expressed as:

$$Score = {\sum }_{k = 0}^{T} {A}_{k}^{2} ( Ξ ) {s}_{k}^{2} {ξ}_{k}$$

or expanding the definition of ξₖ and regrouping terms, may be expressed in terms of attention weights W_{j,k}(X):

$$Score = {\sum }_{j = 1}^{m} {\sum }_{k = 0}^{T} {W}_{j , k} ( X ) {X}_{j , k} ,$$

Returning now to FIG. 4, at operation 410, the predictive data analysis computing entity 115 may include means, such as processing element 205, to determine one or more transformed static features by applying one or more transformation functions to each temporally static feature. In some embodiments, the entity input data object may describe one or more temporally static features. In such an instance, each of the one or more temporally static features may be transformed by applying one or more transformation functions to each temporally static feature to generate a respective transformed static feature. For example, a transformation function may be a ridge function. A static feature vector may be generated by the multi-variate temporal determination machine learning model based on the transformed static features.

For example, generalized additive models may be used in the following formalism. The generalized additive model structure:

G(z)=g₁(z₁)+g₂(z₂)+ . . . +gₚ(zₚ),

may be fit using structured neural networks, where the {gⱼ(·)} are modeled using sub-networks with one-dimensional inputs {zₖ}.

At operation 412, the predictive data analysis computing entity 115 may include means, such as processing element 205, to generate one or more static feature vectors based on the one or more temporally static features. The static feature vectors may be aggregated from the one or more transformed static features g₁(Z₁), . . . , gₚ(Zₚ). The static feature vectors may be transmitted to the downstream model engine 135 alongside the temporal feature time impact vectors, using similar methods as described above in connection with operation 406.

At operation 408, the predictive data analysis computing entity 115 includes means, such as processing element 205, or the like, for determining an overall model response. In some embodiments, the FEATS model is further configured to determine the overall model response based on each of the one or more determined attention head scores. The output from each of the one or more feature attention heads may be processed by the FEATS model by a single combinational attention layer to generate an overall model response.

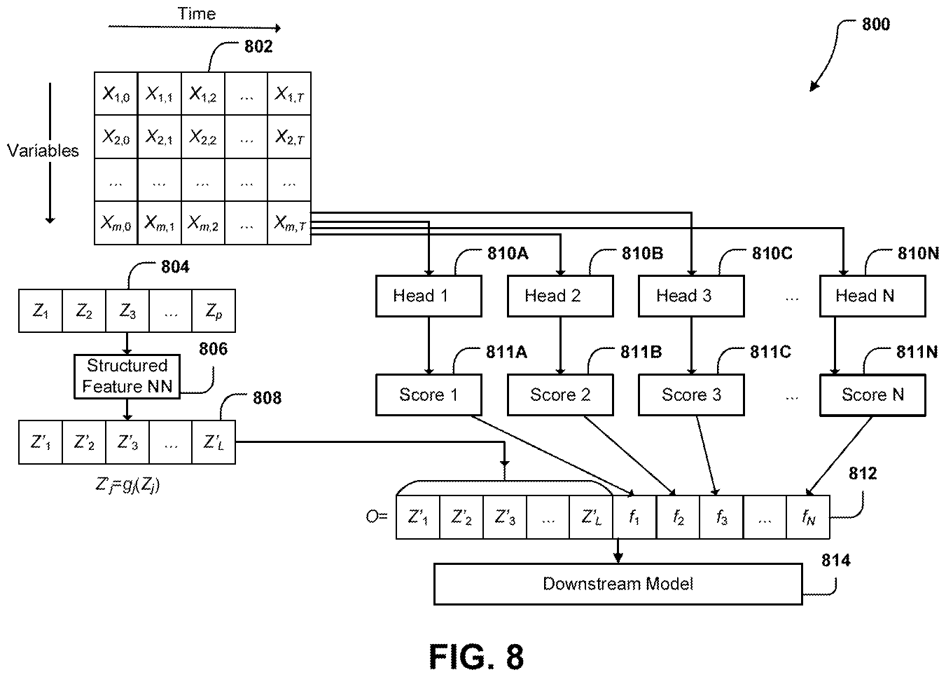

FIG. 8 illustrates an example implementation of the FEATS model 800, including entity input data object including both a temporal feature set 802 and temporally static features 804. As described in connection with operations 410 and 412 previously, the temporally static features may be transformed via structured feature neural network 806, (e.g., a generalized additive model) to generate a static feature vector 808. The temporal feature set 802 may also be given to one or more feature attention heads 810A through 810N. Each feature attention head 810 may operate according to the example process laid out in FIG. 7 to produce an attention head score 811A through attention head score 811N. The attention head scores 811A through 811N may be aggregated (optionally together with the static feature vector 808) to form the aggregated input features 812 provided to a downstream model 814.

The downstream model 814 may link the attention head scores 810A-810N with the overall model response. The downstream model 814 may be embodied by different linear regression models, logistic regression models, or other models. A relatively simple downstream model may avoid adding complexity to the overall model which may compete with the feature attention heads 810A-810N. An overly complex downstream model 814 may capture more complex interactions, but simpler a downstream model 814 may be more explainable and easier to interpret.

In some embodiments, each feature attention head may be configured to attend to a subset of the temporal feature time points of the entity input data object. For example, each feature attention head may be configured to attend on i) the entire temporal feature set, ii) pre-specified subsets of the temporal feature set, or iii) specified time periods.

At operation 414, the predictive data analysis computing entity 115 includes means, such as processing element 205, communications hardware 220, or the like, for generating a predictive temporal feature impact report. In some embodiments, the predictive temporal feature impact report is configured to describe the overall model response, one or more attention head scores, one or more per-temporal feature time impact scores over each time window, one or more temporal feature sets, comparisons between one or more scores, and/or the like. The overall model response may be an overall entity score for the entity associated with the entity input data object with respect to a particular action over the forecast timeframe. By way of continuing example, the entity input data object may describe various stock market trading feature values for a particular portfolio over a period of time and the requested action of a prediction of the direction of change of the value of the stocks in the portfolio within the next 3 milliseconds (e.g., the forecast timeframe). As such, the model response for the entity (e.g., the portfolio) described by the entity input data object may be no change, up, or down. In some embodiments, the model response may be categorical as illustrated in the previous example or alternatively may be numerical, binary, Boolean, and/or the like.

In some embodiments, the predictive data analysis computing entity 115 may automatically generate one or more visualization representations of the overall model response, one or more attention head scores, one or more per-temporal feature time impact scores over each time window, one or more temporal feature sets, comparisons between one or more scores, and/or the like. Visually representative depictions of the one or more aforementioned scores may be presented to one or more end users, which may facilitate interpretability and understanding of multi-variate time series data at various stages of processing. As such, predictive temporal trends within the data may be better understood and used for a range of post-predictive applications.

In some embodiments, the static feature vector is provided as additional input to the single combinational attention layer to generate the overall model response. As such, the multi-variate temporal determination machine learning model may also consider the impact of non-time series values when determining the overall model response.

In addition to the formalism laid out previously for estimating an overall model response given temporal feature set inputs, integrating temporally static features may expand the versatility of the FEATS model. To capture interactions between temporal feature sets and temporally static features, the attention layer for a single time series or vector is adapted to a feature attention layer of the form:

ŷ=ΣⱼAⱼ(O)sⱼOⱼ,

with:

O={Oⱼ}_{j=1:(n+p)}={g₁(Z₁), . . . gₚ(Zₚ),f₁(X), . . . fₙ(X)}

and the A_{1 . . . N}(O) may be calculated from trainable sub-networks.

Instead of the softmax function, the sigmoid activation function may be used when static temporal feature sets are incorporated. The sigmoid activation function may make the selection of a specific feature independent of the selection of others.

In some embodiments the predictive data analysis computing entity 115 may additionally generate one or more variable contribution scores or one or more temporal contribution scores. The variable contribution scores may evaluate the contributions of different temporal feature time points to the attention head scores, and the temporal contribution scores evaluate the contributions of different temporal feature sets to the attention head scores. Recalling from above the expression for the generated features in terms of feature weights:

$${\sum }_{j = 1}^{m} {\sum }_{k = 0}^{T} {W}_{j , k} ( X ) {X}_{j , k} ,$$

the contributions of different time points or time series may be evaluated by comparing the feature with the parts of each time point or time series. The variable contribution scores for a time series x_{j,·} may be computed as

$${\sum }_{k = 0}^{T} {W}_{j , k} ( X ) {X}_{j , k}$$

while the temporal contribution scores for a time point x_{·,k} may be computed as

$${\sum }_{j = 0}^{m} {W}_{j , k} ( X ) {X}_{j , k} .$$

The variance of the generated attention head scores and the contribution scores may quantify the influence of variables and time points to enable users to more easily see the relationship between inputs and generated features.

Optionally, at operation 416, the predictive data analysis computing entity 115 includes means, such as processing element 205, communications hardware 220, or the like, for generating a preliminary risk category for the entity described by the entity input data object. In particular, the predictive data analysis computing entity 115 may be configured to generate a preliminary risk category for the entity based on the overall model response. A preliminary risk category may be indicative of an inferred risk associated with performing the requested action for the entity. A preliminary risk category may include a high-risk preliminary category, a medium-risk preliminary category, and a low-risk preliminary category, for example. By way of continuing example, the overall model response for the portfolio may be an increase in predicted value of the stock and therefore, a preliminary risk category for the portfolio may be determined to be a low preliminary risk category. As another example, an overall model response for the portfolio may be a decrease in predicted value of the stock and therefore, a preliminary risk category for the portfolio may be determined to be a high preliminary risk category.

Optionally, at operation 418, the predictive data analysis computing entity 115 includes means, such as processing element 205, communications hardware 220, or the like, for generating a real-time notification processing output based on the preliminary risk category generated for the entity. In particular, each preliminary risk category may be associated with a particular set of notification processing outputs which the predictive data analysis computing entity 115 may generate. The predictive data analysis computing entity 115 may then generate the set of notification processing outputs and provide the notification processing outputs to one or more user devices, such as a user device associated with an entity, a financial institution employee, or the like and may do so in substantially real-time. The real-time notification processing output may include the predictive temporal feature impact report, including the overall model response, one or more attention head scores, one or more per-temporal feature time impact scores over each time window, one or more temporal feature sets, comparisons between one or more scores, and/or the like.

By way of continuing example, a low preliminary risk category may be associated with a set of registration processing outputs which are configured to output an explanation that a low preliminary risk category is associated with the stocks of the portfolio and further, that the value of the stocks are predicted to increase over the next 3 milliseconds. In some embodiments, the notification processing output may further be configured to execute one or more additional actions, such as buying additional stocks. As such, the notification processing output may provide the explanation of that the portfolio is low risk as well as the data included in the predictive temporal feature impact report and execute one or more purchases of stocks for the entity. The purchased stock may be selected based on user configuration settings, trading history, market rates, via the use of other models, and/or the like. The notification processing output may further be generated and/or updated to include the stock that was purchased. As such, the one or more end users may receive the real-time notification processing output and may obtain an up-to-date and accurate picture of the current state of their portfolio (e.g., that the value is increasing) and may further allow the predictive data analysis computing entity 115 to take additional actions in substantially real-time based on the up-to-date model response and preliminary risk category.

As another example, a high preliminary risk category may be associated with a set of registration processing outputs which are configured to output an explanation that a high preliminary risk category is associated with the stocks of the portfolio and further, that the value of the stocks are predicted to decrease over the next 3 milliseconds. Because a high preliminary risk category was determined, the predictive data analysis computing entity 115 may determine to not buy any additional stock. As such, the notification processing output may provide the explanation of that the portfolio is high risk as well as the data included in the predictive temporal feature impact report and may also indicate that no additional stocks were purchased. As such, the one or more end users may receive the real-time notification processing output and may obtain an up-to-date and accurate picture of the current state of their portfolio (e.g., that the value is decreasing) and may be informed that no additional actions were performed due to the up-to-date model response and preliminary risk category. Additionally, the one or more end users may view the top contributing features as to why their portfolio is decreasing and thus, may be better informed as to that particular model response was determined, thereby improving model interpretability.

FIGS. 4 and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### VII. Example Implementation

### Example 1

An illustrative example implementation consists of three independent time series,

X₁={X_{1,k}}_{k=0:9},X₂={X_{2,k}}_{k=0:9},X₃{X_{3,k}}ₖ₌0:9

simulated independently and identically from the normal distribution N(0,1). A response is generated via

y=f₁(X₁,X₂,X₃)+f₂(X₁,X₂,X₃)

where

f₁(X₁,X₂,X₃)=⅓[max(X_{1,6},X_{2,6})+max(X_{1,7},X_{2,7})+max(X_{1,8},X_{2,8})],

f₂(X₁,X₂,X₃)=⅓(X_{3,1}+X_{3,2}+X_{3,3}).

Note that f₂ provides a simple linear feature of the X₃ time series while f₁ provides a non-linear interaction of X₁ and X₂, and the two functions are orthogonal.

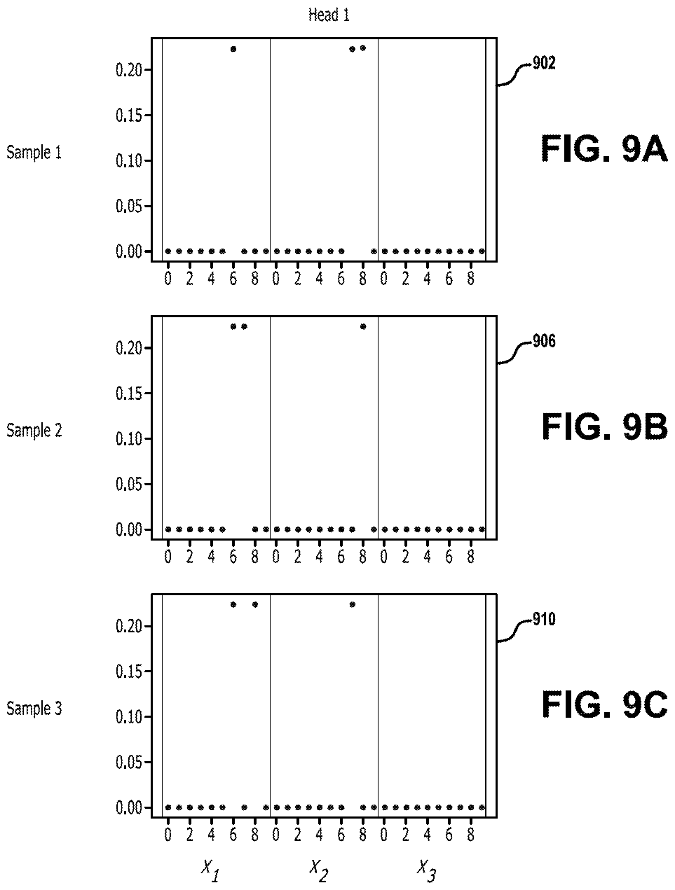

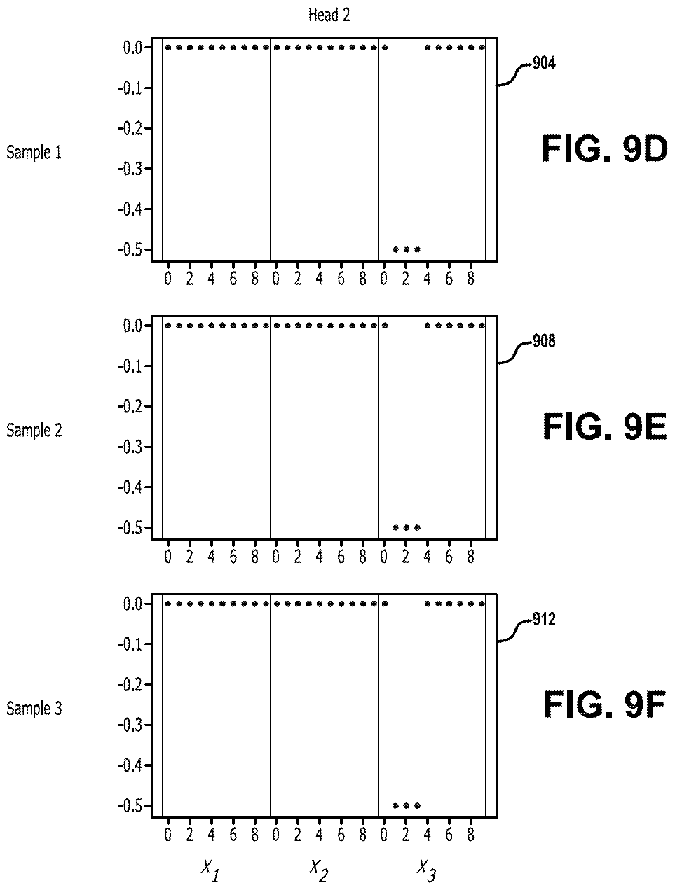

An example FEATS model including two feature attention heads is configured with the width of convolutional attention layers set to zero, so the layers focus on selecting subsets of time series attended by attention heads. The resulting mode generates the summaries depicted in FIG. 9.

As described previously, each attention head score may be expressed as

$$Score = {\sum }_{j = 1}^{m} {\sum }_{k = 0}^{T} {W}_{j , k} ( X ) {X}_{j , k} ,$$

and visualizing the varying attention weights W_{j,k}(X) may aid in understanding the process of generating attention head scores.

The plot 902 shows the weights of feature attention head 1 for the first sample, while plots 906 and 910 show the same for the second and third samples, respectively. As indicated by the plots, the first attention head score is proportional to (X_{1,6}+X_{2,7}+X_{2,8}), the second attention head score is proportional to (X_{1,6}+X_{1,7}+X_{2,8}), and the third attention head score is proportional to (X_{1,6}+X_{2,7}+X_{1,8}). The right column of plots, including plot 904, plot 908, and plot 912 only have non-zero values corresponding to the X₃ time series. In this example, the visualization of attention weights is shown to clearly illustrate the patterns found in input samples. Table 1 shows the variance of generated attention weights and contribution scores.

TABLE 1
Variance of generated attention weights and their contribution scores

| | Feature | x₁,. | x₂,. | x₃,. | x.,₀ | x.,₁ | x.,₂ | x.,₃ | x.,₄ | x.,₅ | x.,₆ | x.,₇ | x.,₈ | x.,₉ |
|---|---|---|---|---|---|---|---|---|---|---|---|---|---|---|
| Head1 | 0.101 | 0.063 | 0.061 | 0 | 0 | 0 | 0 | 0 | 0 | 0 | 0.034 | 0.033 | 0.034 | 0 |
| Head2 | 0.728 | 0 | 0 | 0.728 | 0 | 0.024 | 0.025 | 0.025 | 0 | 0 | 0 | 0 | 0 | 0 |

### Example 2

As another example, a simulated dataset with continuous response was used to illustrate performance and interpretability of the FEATS model. The dataset had 55,000 samples that were split into 50,000 for training and 5,000 for testing. Each sample consisted of two time series X₁^{[i]}={X_{1,k}^{[i]}}_{k=0:49} and X₂^{[i]}={X_{2,k}^{[i]}}_{k=0:49} as features (e.g., predictors). These were simulated from two independent heteroscedastic error processes ARCH(1). The outcomes were simulated using the model:

yᵢ=0.005*(X_{1,10}^{[i]}+3X_{1,11}^{[i]}+5X_{1,12}^{[i]}+3X_{1,13}^{[i]}+X_{1,14}^{[i]}−X_{1,15}^{[i]}−3X_{1,16}^{[i]}−5X_{1,17}^{[i]}−3X_{1,18}^{[i]}−X_{1,19}^{[i]})+0.5*max(X_{1,30:34}^{[i]})+avg(min(X_{1,l}^{[i]},X_{2,k}^{[i]}))_{k=42:46}+0.1∈_{i k=}42:46

where ∈ᵢ is approximately equal to N*(0,1) (e.g., where N the number of samples). The true model can be decomposed by three features: a linear weighted sum of X₁^{[i]}, a non-linear maximum term of X₁^{[i]} and a complex interaction term between X₁^{[i]} and X₂^{[i]}. These components overlap across time series.

The FEATS algorithm was implemented with three feature engineering heads. For each head, the width of the convolutional attention layer r was set at 3. The attention neural networks were selected as shallow networks with two hidden layers and 10 nodes for each layer. Rectified linear unit (ReLU) activation was used with no L1 and L2 penalization. For the continuous outcome, a simple linear model as the downstream model.

Table 2 shows the performance metrics (MSEs). As shown in table 2, the FEATS algorithm has better performance compared to XGB and FFNN (with 2 hidden layers, 40 nodes each layer). MSE of FEATS is close to 0.10 which is the variance of the noise in the true model.

TABLE 2
Performance of simulated dataset

| | XGB | FFNN | FEATS |
|---|---|---|---|
| MSE on Training Dataset | 0.013 | 0.0105 | 0.010 |
| MSE on Validation Dataset | 0.0105 | 0.0120 | 0.0108 |

Additionally, table 3 shows that the feature generated by Head1 is strongly correlated with the linear weighted sum of X₁^{[i]}, that for Head2 is strongly correlated with max (X_{1,30:34}^{[i]}), and the feature for Head3 is strongly correlated with avg (min(X_{1,k}^{[i]},X_{2,k}^{[i]}))_{k=42:46}. The generated features in this example have distinct separation. In real applications, the features are likely to be more correlated.

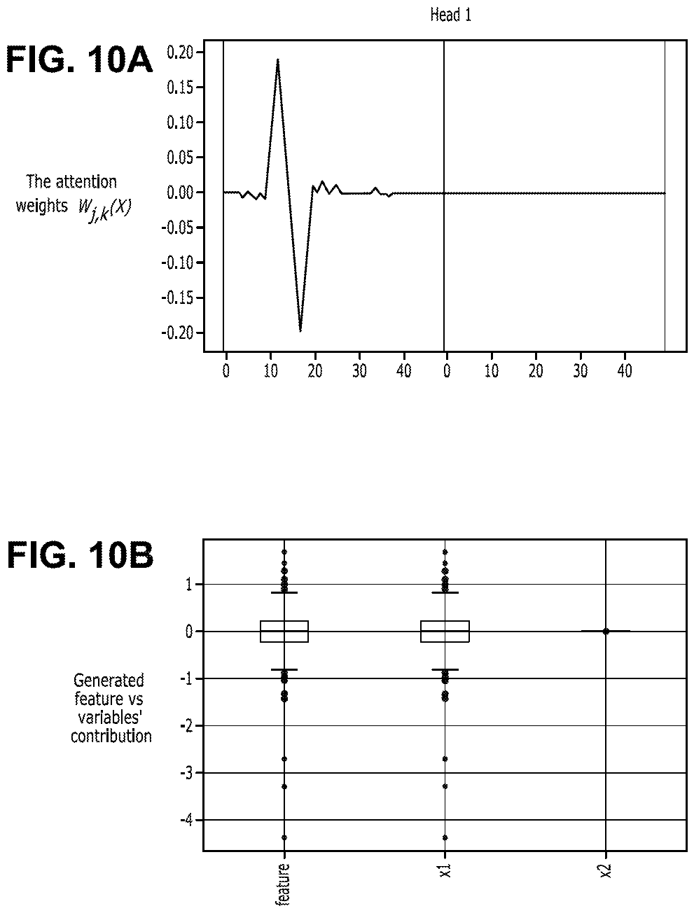

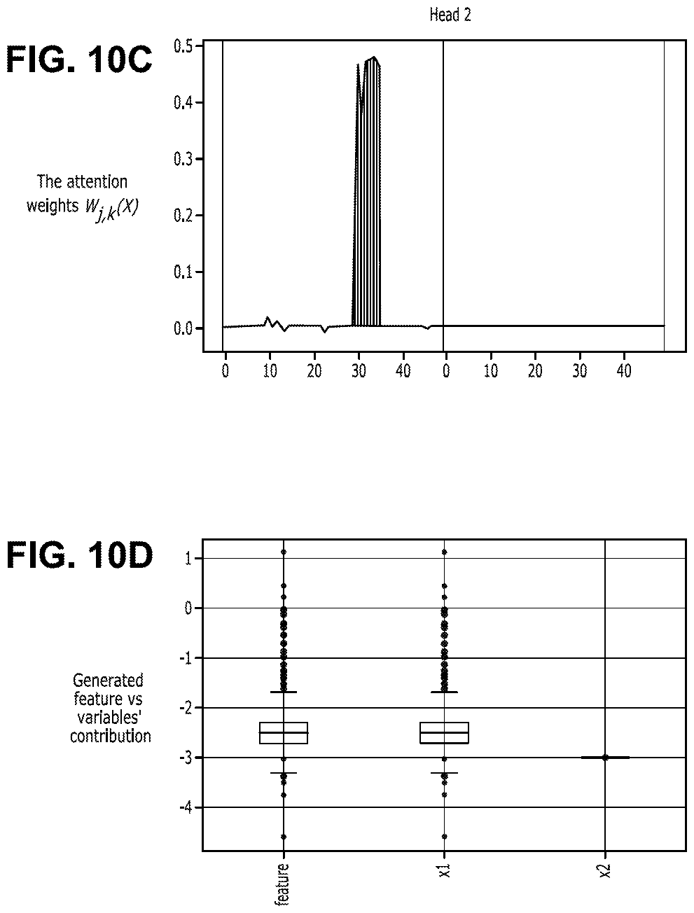

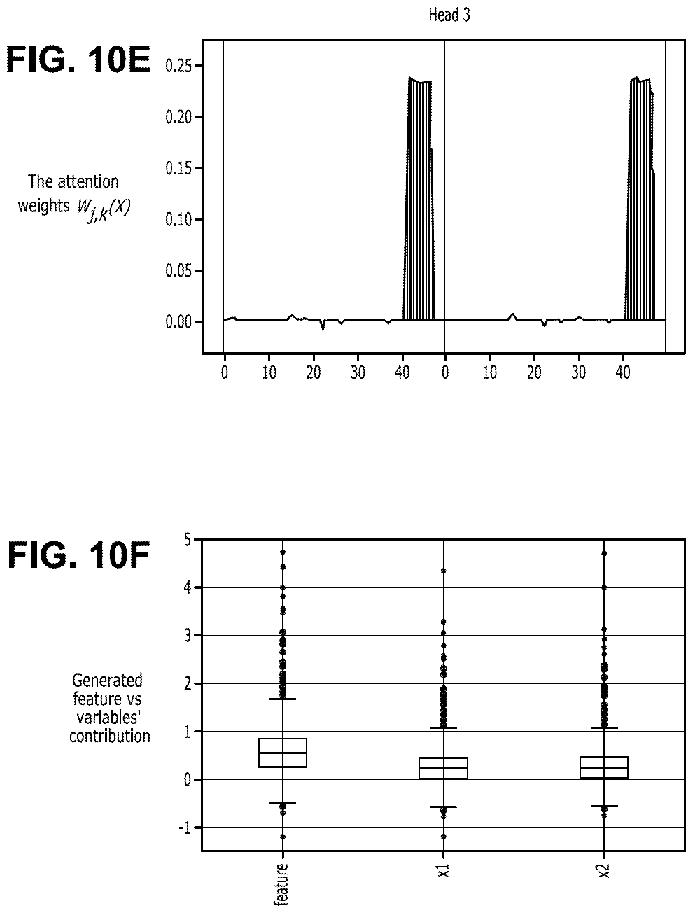

As noted earlier, the results from the FEATS algorithm can also be interpreted by applying the visualization and explanation approaches. The first row of FIG. 10 is similar to FIG. 9, but it shows 50 randomly selected samples W_{j,k}(X) of the focal head stacked on the same panel. For Head1, the curves of different samples are overlapping with each other, which means that the selection on variables and time points consistently give the same weights to the same variables and time points. The pattern represents the specific linear combination from the data-generating model. For Head2, the weights are different across samples with spikes for variable X₁^{[i]} from time point 30 to 34, which aligns with max (X₁^{[i]}). For Head3, the weights are different across sample with spikes for variable X₁^{[i]} and X₂^{[i]} from time point 42 to 46. The weights of pair X₁^{[i]} and X₂^{[i]} are positive and add up to a constant number for each i. The pattern represents the complex non-linear interaction of avg(min(X_{1,k}^{[i]},X_{2,k}^{[i]}))_{k=42:46}.

The second row of the plots shows the comparison of generated features with the components of the time series and time points internally. The feature of Head 1 is constructed by X₁^{[i]} variable from time 10 to 19; the feature of Head2 is constructed by X₁^{[i]} variable from time 30 to 34; and the feature of Head3 is constructed by both X₁^{[i]} and X₂^{[i]} with equal contribution from time 42 to 46. These observations are aligned with our finding in table 3 and explain how the feature engineering heads recover the data generating model.

### Example 3

The performance of the FEATS model is compared to several other conventional models using a dataset that includes high frequency predictions of the market based on streaming tick data from a book service. The direction of the mid-price change in next 3 milliseconds could be: i) no change (=0), ii) up (=1), or iii) down (=2). The predictors are multivariate time series consisting of 17 dynamic features computed online from streaming tick data. They represent the current value and the 10 previous ticks, such as current top of order book bid/ask size, current spread on order book. The length of time series is 11. The training data sample size is 352010, the validation data sample size is 72400, and the test data sample size is 162903.

The FEATS algorithm used 10 heads to extract features from the 17 dynamic variables at the 11 different time points. It used a linear dense layer with softmax activation as the downstream model. The benchmark models were XGBoost using the snapshot time data only (XGB1), XGBoost using all the data (XGB2), a long short-term memory model (LSTM), a generalized additive model network (GAM-Net), and an explainable neural network (XNN). Hyper-parameters of all the models were on validation dataset. Performance measures on training and test datasets are listed in table 3. Here 0 indicates an overall model response of no change, 1 indicates an overall model response of increase, and 2 indicates an overall model response of decrease. Since the outcome has three different categories, AUC was calculated as the focal category against the others, and cross entropy loss of multi-class regression is provided.

TABLE 3
Model performance on trading dataset

| AUC (one vs. | Train AUC | | | Test AUC | | | Cross Entropy | |
|---|---|---|---|---|---|---|---|---|
| others) | 0 | 1 | 2 | 0 | 1 | 2 | Train | Test |
| XGB1 | 0.924045 | 0.97996 | 0.979614 | 0.916172 | 0.97945 | 0.978548 | 0.3279 | 0.3347 |
| XGB2 | 0.944287 | 0.985366 | 0.985042 | 0.923558 | 0.981078 | 0.980518 | 0.2862 | 0.3205 |
| LSTM | 0.923012 | 0.979095 | 0.978634 | 0.919857 | 0.980144 | 0.979396 | 0.3329 | 0.3298 |
| GAMnet | 0.923167 | 0.978915 | 0.978846 | 0.920274 | 0.980388 | 0.979758 | 0.3349 | 0.3306 |
| XNN | 0.926773 | 0.980532 | 0.980803 | 0.919623 | 0.980465 | 0.980698 | 0.3246 | 0.3287 |
| FEAT | 0.926549 | 0.980497 | 0.98019 | 0.922103 | 0.980905 | 0.979738 | 0.3221 | 0.3283 |

As shown in Table 3, only XGB2 achieved slightly better performance than FEATS on the test dataset. But it has a larger loss-gap between the training and test datasets indicating less robustness. Also, FEATS has better model explainability than the XGBoost benchmarks.

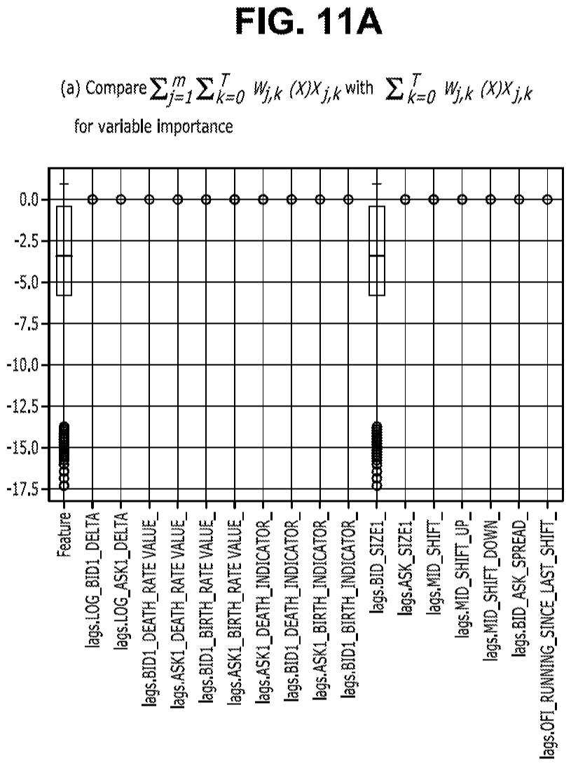

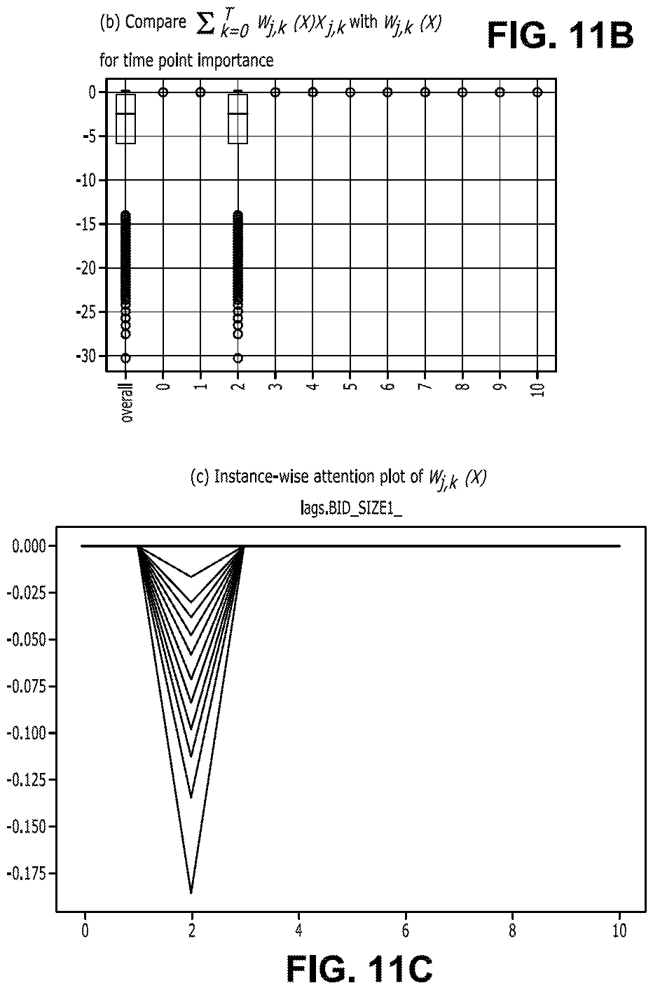

The generated features are quite interpretable. By applying the above described approaches, the results shown in FIG. 11. The lags.BID_SIZE1 is the driven variable of the feature, and time 2 (2 ticks before current) influence more than other time points.

### CONCLUSION

As described above, the FEATS model improves on conventional model interpretability and thus provides for a more robust and intuitive model that is capable of accurate prediction forecasting while also providing for interpretability of the impact of various features (e.g., particular temporal feature time points, temporal feature sets (e.g., features), attention head scores, and/or the like).

As described above, the FEATS model also addresses technical challenges for preserving the multi-variate temporal structure of input data by using one or more feature attention heads, which each generate a respective attention head score. Each feature attention head is associated with a feature attention layer configured to process each temporal feature set over an associated time window without concatenating the input data. The time window may be customized for each feature attention head. Thus, the FEATS model may preserve the structure of the multi-variate temporal feature data and thus, maintain the time-dependent integrity of such data.

Furthermore, in some embodiments, FEATS model may additionally consider the impact of temporally static features, thereby allowing for a hybrid predictive model which is indicative of the impact of both time-dependent and time-independent features. The FEATS model may transform the one or more temporally static features by applying one or more transformation functions to each temporally static feature to generate respective temporally static features and further, generate a static feature vector based on the one or more transformed static features. The static feature vector may be used when determining the one or more overall model response and used in the predictive temporal feature impact report.

Additionally, the architecture of the FEATS model allows for parallel processing of each temporal feature set by the one or more feature attention heads. As such, the one or more attention head scores generated by each feature attention head may be generated using one or more separate processing elements, computing entities, and/or the like. This allows for a reduction in the required computational time and the computational complexity of runtime operations on a single processing element and/or computing entity while still maintaining model accuracy.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for generating a predictive temporal feature impact report for an entity using a feature engineering machine with attention for time series (FEATS) model including one or more feature attention heads, the computer-implemented method comprising:
receiving, by communications hardware, an entity input data object, wherein: i) the entity input data object describes one or more temporal feature sets, ii) each temporal feature set includes one or more temporal feature time points, and iii) the one or more temporal feature time points are ordered temporally within the entity input data object;
for each feature attention head included in the FEATS model, determining, by an attention head engine and using the FEATS model, an attention head score based on the one or more temporal feature time points for each temporal feature set within a series of time windows; and
generating, by a downstream model engine, the predictive temporal feature impact report based on one or more determined attention head scores.

2. The computer-implemented method of claim 1, wherein determining the attention head score for a feature attention head comprises:
determining, by the attention head engine and using the FEATS model, a per-temporal feature time impact score for each time window associated with the feature attention head;
determining, by the attention head engine and using the FEATS model, a temporal feature time impact vector based on one or more determined per-temporal feature time impact scores; and
determining, by the attention head engine and using the FEATS model, the attention head score for the feature attention head based on the temporal feature time impact vector.

3. The computer-implemented method of claim 2, wherein determining the attention head score for a feature attention head further comprises:
training, by the attention head engine and using the FEATS model, a set of trainable parameters of the feature attention head.

4. The computer-implemented method of claim 1, further comprising:
determining, by the downstream model engine and using the FEATS model, an overall model response based on the one or more determined attention head scores;
wherein the predictive temporal feature impact report is based on the overall model response.

5. The computer-implemented method of claim 1, wherein the entity input data object further describes one or more temporally static features, and the computer-implemented method further comprises:
generating, by a temporally static feature engine and using the FEATS model, one or more static feature vectors based on the one or more temporally static features; and
determining, by the downstream model engine and using the FEATS model, an overall model response based on the one or more determined attention head scores and the one or more static feature vectors;
wherein the predictive temporal feature impact report is based on the overall model response.

6. The computer-implemented method of claim 5, wherein the computer-implemented method further comprises:
determining, by the temporally static feature engine and using the FEATS model, one or more transformed static features by applying one or more transformation functions to each temporally static feature,
wherein generating the one or more static feature vectors is based on the one or more transformed static features.

7. The computer-implemented method of claim 1, further comprising:
receiving, by the communications hardware, a set of hyperparameters, wherein the set of hyperparameters comprises:
a number of feature attention heads to be included in the FEATS model,
a number of network layers to be included in each feature attention head,
a number of network nodes for each network layer to be included in each feature attention head,
an activation function to be included in each feature attention head,
a width of a rolling window to be utilized by each feature attention head,
a regularization parameter to be utilized by each feature attention head, or
a combination thereof.

8. The computer-implemented method of claim 1, wherein each feature attention head is configured to attend to a subset of the one or more temporal feature time points of the entity input data object.

9. The computer-implemented method of claim 1, further comprising:
generating, by the attention head engine and using the FEATS model, one or more variable contribution scores or one or more temporal contribution scores, wherein the one or more variable contribution scores evaluate contributions of different temporal feature time points to the one or more determined attention head scores, wherein the one or more temporal contribution scores evaluate contributions of different temporal feature sets to the one or more determined attention head scores.

10. An apparatus for generating a predictive temporal feature impact report for an entity using a FEATS model including one or more feature attention heads, the apparatus comprising:
communications hardware configured to receive an entity input data object, wherein: i) the entity input data object describes one or more temporal feature sets, ii) each temporal feature set includes one or more temporal feature time points, and iii) the one or more temporal feature time points are ordered temporally within the entity input data object;
an attention head engine configured to, for each feature attention head included in the FEATS model, determine, using the FEATS model, an attention head score based on the one or more temporal feature time points for each temporal feature set within a series of time windows; and
a downstream model engine configured to generate the predictive temporal feature impact report based on one or more determined attention head scores.

11. The apparatus of claim 10, wherein the attention head engine is further configured such that determining the attention head score for a feature attention head further comprises:
determining, using the FEATS model, a per-temporal feature time impact score for each time window associated with the feature attention head;
determining, using the FEATS model a temporal feature time impact vector based on one or more determined per-temporal feature time impact scores; and
determining, using the FEATS model, the attention head score for the feature attention head based on the temporal feature time impact vector.

12. The apparatus of claim 11, wherein the attention head engine is further configured such that determining the attention head score for a feature attention head further comprises:
training, using the FEATS model, a set of trainable parameters of the feature attention head.

13. The apparatus of claim 10, wherein the downstream model engine is further configured to:
determine, using the FEATS model, an overall model response based on the one or more determined attention head scores;
wherein the predictive temporal feature impact report is based on the overall model response.

14. The apparatus of claim 10, wherein the entity input data object further describes one or more temporally static features, and the apparatus further comprises a temporally static feature engine configured to generate, using the FEATS model, one or more static feature vectors based on the one or more temporally static features;
wherein the downstream model engine is further configured to determine, using the FEATS model, an overall model response based on the one or more determined attention head scores and the one or more static feature vectors;
wherein the predictive temporal feature impact report is based on the overall model response.

15. The apparatus of claim 14, wherein the temporally static feature engine is further configured to determine, using the FEATS model, one or more transformed static features by applying one or more transformation functions to each temporally static feature;
wherein generating the one or more static feature vectors is based on the one or more transformed static features.

16. The apparatus of claim 10, wherein the communications hardware is further configured to:
receive a set of hyperparameters comprising:
a number of feature attention heads to be included in the FEATS model,
a number of network layers to be included in each feature attention head,
a number of network nodes for each network layer to be included in each feature attention head,
an activation function to be included in each feature attention head,
a width of a rolling window to be utilized by each feature attention head,
a regularization parameter to be utilized by each feature attention head, or
a combination thereof.

17. The apparatus of claim 10, wherein each feature attention head is configured to attend to a subset of the one or more temporal feature time points of the entity input data object.

18. The apparatus of claim 10, wherein the attention head engine is further configured to generate, using the FEATS model, one or more variable contribution scores or one or more temporal contribution scores, wherein the one or more variable contribution scores evaluate contributions of different temporal feature time points to the one or more determined attention head scores, wherein the one or more temporal contribution scores evaluate contributions of different temporal feature sets to the one or more determined attention head scores.

19. A computer program product for generating a predictive temporal feature impact report for an entity using a FEATS model including one or more feature attention heads, the computer program product comprising at least one non-transitory computer-readable storage medium storing software instructions that, when executed, cause an apparatus to:
receive an entity input data object, wherein: i) the entity input data object describes one or more temporal feature sets, ii) each temporal feature set includes one or more temporal feature time points, and iii) the one or more temporal feature time points are ordered temporally within the entity input data object;
for each feature attention head included in the FEATS model, determine, using the FEATS model, an attention head score based on the one or more temporal feature time points for each temporal feature set within a series of time windows; and
generate the predictive temporal feature impact report based on one or more determined attention head scores.

20. The computer program product of claim 19, wherein determining the attention head score for a feature attention head comprises:
determining, the FEATS model a per-temporal feature time impact score for each time window associated with the feature attention head;
determining, using the FEATS model a temporal feature time impact vector based on one or more determined per-temporal feature time impact scores; and
determining, using the FEATS model, the attention head score for the feature attention head based on the temporal feature time impact vector.
